(19) United States
(12) Patent Application Publication
(10) Pub. No.: US 2010/0009583 A1
(43) Pub. Date: Jan. 14, 2010

(54) FLAME RETARDANT, STAIN AND SOIL RESISTANT TEXTILE ARTICLE

(75) Inventors: Joseph F. Bringley, Rochester, NY (US); Tiecheng Qiao, Webster, NY (US); Suresh Sunderrajan, Rochester, NY (US)

Correspondence Address: BASCH & NICKERSON LLP, 1777 PENFIELD ROAD, PENFIELD, NY, 14526, US

(73) Assignee: BigSky Technologies LLC, Rochester, NY (US)

(21) Appl. No.: 12/504,368

(22) Filed: Jul. 16, 2009

Related U.S. Application Data
(63) Continuation-in-part of application No. 11/859,308, filed on Sep. 21, 2007.
(60) Provisional application No. 61/135,237, filed on Jul. 18, 2008.

(51) Int. Cl. B32B 5/02; B05D 3/00; C09D 5/18

(52) U.S. Cl. 442/80; 427/331; 106/15.05

(57) ABSTRACT

Disclosed are embodiments and methods relating to the treatment of textile, such as a textile substrate, with an aqueous dispersion of surface-functionalized particles and a fluorochemical, or a textile substrate treated with an aqueous dispersion of surface-functionalized particles, a fluorochemical, and a flame retardant chemical. Textiles treated in accordance with the disclosed embodiments (e.g., fluorine concentration of from 20 to 900 ppm) demonstrate an average burn rate less than about 4.0 inch/minute, and an average weight loss is less than about 40% of the original weight. During burning of the treated textile, flaming drips extinguish (on average) in less than about 2 seconds, or does not increase the peak heat release rate by more than about 70%, and the mass loss rate by more than about 50%.

This application is a continuation-in-part of U.S. patent application Ser. No. 11/859,308, for a “STAIN AND SOIL RESISTANT TEXTILE ARTICLE,” filed Sep. 21, 2007 by Joseph F. Bringley et al., which claims priority from U.S. Provisional Patent Application 60/827,718, for a “TEXTILE FINISHING TREATMENT,” filed Oct. 1, 2006 by Suresh Sunderrajan, both of which are hereby incorporated by reference in their entirety. This application claims priority to both of the above-identified applications (U.S. Ser. No. 11/859,308 and U.S. Ser. No. 60/827,718), and further claims priority to U.S. Provisional Patent Application 61/135,237, for a “FLAME RETARDANT, STAIN AND SOIL RESISTANT TEXTILE ARTICLE,” filed Jul. 18, 2008 by Joseph F. Bringley, which is also hereby incorporated by reference in its entirety.

The embodiments and methods disclosed herein relate to textile products treated with surface-functionalized particles, in combination with a fluorochemical, that are flame resistant and simultaneously are stain, soil resistant and water/oil repellent.

### BACKGROUND AND SUMMARY

Materials and processes for rendering the surfaces of articles water, oil, stain and soil resistant are in great demand in industries such as paints and coatings, textiles, paper, construction materials, marine materials, glass and windows, plastics, metals, and many others. Such materials provide protection from wear and dirt and improve the aesthetic qualities and lifetime of industrial and consumer articles. Currently, water, oil, stain and soil resistance is achieved by lowering the surface energy of a material such that water, oil and dirt do not stick to, or wet, the surface of the article. The water and/or oil simply rolls off, or can be easily removed from the article. This is commonly achieved today by applying a fluorochemical or fluoropolymer to the surface of an article and is typically done by applying a solution or suspension of the fluorochemical in water, or solvent, removing the liquid phase by drying and thereby forming a thin fluoropolymer film on the surface of the article. The fluorochemical or fluoropolymer lowers the surface energy and a water and oil resistant coating is obtained. Such coatings find many applications in textile fabrics where stain resistant clothing, carpets, upholstery, and draperies have become commonplace.

There is a problem, however, in that fluorochemicals, and textile finishes derived from fluorochemicals may increase the flammability of the fabric and cause the fabric to fail specified flammability tests. This problem was recognized by DeMott, as discussed in U.S. Pat. No. 4,355,065: “in the area of automotive upholstery applications, the flame retardant standards which have been imposed upon the materials by the U.S. Government have been such that it has been thought to be impossible to render the materials oil and water repellent while the same time meeting such government standards.”

There is a need for materials, methods and processes for rendering textiles, also referred to herein as fabrics, water, oil, stain and soil resistant but, at the same time, that do not increase the flammability of the textile. There is a need for textiles that are water, oil, stain and soil resistant but that also pass specified flammability standards and codes.

U.S. Pat. No. 4,355,065 to DeMott, incorporated herein by reference, discloses a fluoropolymer-modified textile material particularly suitable for automotive upholstery applications having improved soil resistance and flammability characteristics. Disclosed herein is a textile consisting of synthetic fibers, wherein a oil- and water-repellent fluoropolymer is evenly distributed on the face of the textile in an amount sufficient to improve the soil resistance characteristics but insufficient to cause the material to burn at a rate in excess of about 2 inches per minute. The textile further having been back coated with a flame retardant backing. However, such back-coatings are expensive and can make the fabric stiff.

U.S. Pat. No. 6,759,127 to Smith et al., incorporated herein by reference, discloses a textile article having flame resistant properties that includes a plurality of inherently resistant flame retardant polyester fibers formed into a fabric, and a finish on the fabric wherein the finish imparts a property selected from an antimicrobial, a soil repellent and a fluid repellent. There is a problem, however, in that 100% inherent flame resistant polyester fibers are expensive and further, in some instances, the stain repellent finish may still cause the fabric to fail specified tests.

Still, there remains disagreement in the literature as to the extent and magnitude of the problem. Dix and DeLong, in an article entitled “Repellent Treatments on Stretchable and/or Inherently Flame Retardant Fabrics”, in Performance of Protective Clothing, Vol IV, ASTM Digital Library, No. STP1133-EB, 1992, examined fluorochemical treatments on inherently flame retardant fabrics and noted “all exhibited excellent repellent properties (oil, water, phosphate) after treatment. Laundering of treated materials only reduced the oil repellency somewhat and had no effect on the phosphate or water repellencies. The flame retardancy was not degraded by the repellent treatment.”

It is desirable therefore to provide a water and oil repellent composition that performs reliably and does not increase significantly the flammability of a fabric. It is further desirable to provide stain, soil, water and oil repellent finishes on fabrics that do not require a flame retardant back coating or 100% inherently flame retardant yarn to pass specifications.

The embodiments disclosed herein relate to textile products that are flame resistant and simultaneously are stain, soil resistant and water/oil repellent. It has been discovered that surface-functionalized particles, preferably inorganic oxides and/or oxy-hydroxides, in combination with a fluorochemical, greatly enhance the water and oil repellency at low fluorochemical concentrations of from about 20-900 ppm, as measured by the concentration of atomic fluorine (F), on the fabric. It has further been discovered that these surface functionalized particle-based soil and stain repellent compositions do not significantly impact the flammability of textile substrates, since the preferred primary component of these formulations are metal-oxide particles such as silica, alumina, or other mineral particles. Silica, alumina, and other inorganic mineral particles are non-flammable and therefore should not add flammability to the substrate upon which they are applied.

The disclosed embodiments provide treatment compositions that render textiles highly stain and soil repellent, and further enable the textile to pass specified fire codes, even when applied to textile fabric that is not inherently flame retardant.

Disclosed in embodiments herein is a treated textile comprising: a textile substrate treated with an aqueous dispersion of surface-functionalized particles and a fluorochemical, wherein the treated textile exhibits oil repellency, water repellency, has a low fluorine concentration, and is flame resistant.

Also disclosed in embodiments herein is a treated textile comprising: a textile substrate treated with an aqueous dispersion of surface-functionalized particles and a fluorochemical; and at least one flame retardant chemical, wherein the treated textile exhibits oil repellency, water repellency, has a low fluorine concentration, and is flame resistant.

Further disclosed in embodiments herein is a method for treating textiles to impart stain resistance and flame resistance comprising: a. providing a textile substrate; b. contacting said substrate with a stable aqueous dispersion of surface-functionalized particles and a fluorochemical to produce a treated textile substrate; and c. finishing said treated textile substrate, wherein the flammability of the finished and treated textile substrate passes fire code flammability standards of: an average burn rate less than 4.0 inch/minute, as determined by FMVSS-302; the average weight loss is less than 40% of the original weight and the flaming drips extinguish (on average) in less than 2 seconds, as determined by NFPA-701-99; or does not increase the peak heat release rate by more than 70%, and the mass loss rate by more than 50% as determined by cone calorimetry; and has an oil repellency of 3 or greater, a water repellency of 3 or greater and a fluorine concentration by weight of treated textile of from about 20 to about 900 ppm.

### DETAILED DESCRIPTION

As more particularly set forth below, the disclosed system and methods relate to a textile substrate treated with an aqueous dispersion of surface-functionalized particles and a fluorochemical, wherein the flammability of the treated textile passes fire code flammability standards and the treated textile has an oil repellency of 3 or greater, a water repellency of 3 or greater and a fluorine concentration by weight of treated fabric of from about 20 to about 900 ppm.

The disclosure is directed toward producing stain resistant and water/oil repellent compositions that greatly minimize the need for fluorochemicals, and further do not negatively impact the flammability of the article treated with the compositions. The disclosure is further directed toward producing stain resistant and water/oil repellent textiles that are able to pass flammability requirements or codes.

### TERMS AND DEFINITIONS

Fluorochemical concentrate is used herein to mean the fluorochemical solution or dispersion as received from the manufacturer or supplier.

Fluorochemical as defined herein refers to the active or solids portion of commercial fluorochemical concentrates as supplied by manufacturers, i.e., water is excluded.

Organo-fluorine group means any molecular group that is fluorinated or partially fluorinated and has at least one alkylfluorene subunit given by the general formula (CₙF₂ₙ₊₁—), where n is greater than or equal to 3.

Fluorine concentration means the concentration of atomic fluorine (F), either in the treating solution or on the fabric, as specified.

Treating solution as used herein refers to the final diluted solution, including all addenda, that is used to treat the dry (untreated) fabric.

Surface-functionalized particles as used herein refers to particles functionalized with inorganic, polymeric or molecular species.

Surface-modified particles as used herein refers to surface-functionalized particles which have been further reacted with other compounds bearing functional groups to produce a complex particle bearing a compound or compounds on its surface through the surface-functionalization.

Textile substrates suitable for application of the disclosed treatment include all woven and non-woven textiles, including those used for clothes, apparel, sports wear, and rain jackets. Other suitable textile substrates include those used for furniture or interior textiles, such as upholstery, drapes, carpets, curtains, and wall-coverings. Outdoor and industrial textiles are suitable substrates, such as tents, tarps, awnings, covers, boat-covers, and outdoor carpets. The textile substrates may be synthetic (man-made fibers) or natural. Suitable fabrics include, but are not limited to, cotton, wool, ramie, polyester, polypropylene, nylon, rayon, acrylic, lycra, nomex, and their blends. The textile substrate may comprise non-flame retardant yarns or inherently flame retardant yarns. Inherently flame retardant yarns are yarns that have chemical flame retardants incorporated directly into the fibers and often directly into the backbone of the polymer that comprises the fibers. Examples include inherently flame retardant polyesters such as Trevira®, Kosa®, and Avora®, which are available commercially.

The textile substrate is treated with an aqueous dispersion of surface-functionalized or surface-modified particles, and a fluorochemical. Preferably, the particles, prior to functionalization and/or modification, have a mean particle diameter of less than 500 nm. Particles having a diameter of less than 500 nm may also be referred to as nanoparticles.

The surface-functionalized particles most preferably comprise surface-functionalized inorganic particles. Inorganic particles are generally non-flammable and therefore minimize the impact upon the flammability of the treated textile article. In one embodiment the inorganic particles are selected from metal-oxide and/or metal oxy-hydroxide particles having a mean particle diameter of from 2 to 500 nm. For example, the inorganic particles may be silicon oxide (silica). Preferably the particles have a mean particle diameter of from 5 to 250 nm, and more preferably of from 10 to 100 nm. The metal-oxide inorganic particles are preferably selected from aqueous dispersible metal-oxide particles including, but not limited to, silica, alumina, zirconia, titania, zinc oxide, and mixtures thereof. Specific examples include colloidal, precipitated or fumed silica, aluminas such as Al₂O₃ and its polymorphs, AlOOH (also known as boehmite), ZrO₂ and its oxy-hydroxide derivatives and related metal salts and derivatives, TiO₂ and ZnO.

Also useful for carrying out the disclosed embodiments are mixed metal oxy-hydroxides and clay minerals such as layered double hydroxides, hydrotalcite, smectic clays, hydroxy double salts, layered siliceous materials. Specific examples include:

layered double hydroxides (related to the mineral hydrotalcite) of the general formulas:

[M²⁺₁₋ₓM³⁺ₓ(OH)₂]Aⁿ⁻_{x/n}.yH₂O

or

[M¹⁺M³⁺₂(OH)₆]Aⁿ⁻_{n/x}.yH₂O,

where M¹⁺ is typically Li or Na, M²⁺ is typically Ca or Mg, and M³⁺ is typically Fe or Al, A is an anion and is typically NO₃⁻, Cl⁻, or CO₃²⁻, and layered siliceous materials such as natural or synthetic clay minerals exemplified by montmorillonite, bentonite, kaolin, vermiculite, talc and saponite, given by the general formula:

[M1,M2]ₙZ₄O₁₀(OH)₂._{y}H₂O._{w},

where M1 is typically Al or Fe, M2 is typically Mg or Zn, and Z is Al or Si.

The preferred inorganic particles are colloidal, precipitated or fumed silicas having the general formula SiO₂. The particles are preferably stable aqueous colloidal mixtures. A stable aqueous colloidal mixture is one that does not settle or separate from aqueous dispersion for a period of at least one month or more.

The surfaces of the particles of the disclosed embodiments, preferably inorganic metal-oxide particles, are functionalized with inorganic, polymeric or molecular species to create the “surface-functionalized particles.” The functionalized surfaces serve to convert the surface characteristics of the particles from hydrophilic to hydrophobic and, further, to provide a functionality such that the particles may be cross-linked (chemically bound) to the textile article and/or to reactive sites on the fluorochemical. Cross-linking serves to provide durability to the finish such that the stain and water/oil repellent properties survive launderings, weather (for outdoor fabrics), use and abrasion.

The surfaces of the particles, for example, inorganic metal-oxide or metal oxy-hydroxide particles, of the disclosed embodiments are functionalized using surface functionalizing agents. The surface functionalizing agents are chemically linked to the particle, either through covalent bonding or through charge attraction. The surface functionalizing agents further preferably contain a “functional group” that is free to react with functional groups on the surfaces of the fabric, or with polymeric addenda in the treatment solution such as fluorochemicals, aliphatic polymers, resins and/or waxes. Surface-functionalized particles bearing compounds from the added treating solution or other addenda that are reacted to the particle through the surface functionalities are referred to herein as surface-modified particles. Suitable functional groups, capable of forming chemical bonds with the fabric or with polymeric addenda, include carboxylate groups, hydroxyl groups, amine groups, amide groups, and thiol groups, and also include complexing inorganic metals or complexes, such as aluminates, silicates and zirconates.

Surface functionalizing agents suitable for practice of the disclosed embodiments include cationic inorganic sols of aluminum and zirconium, such as aqueous solutions of ZrOCl₂, ZrO(NO₃)₂, ZrO(OH)acetate and Al₂(OH)₅Cl. These materials are available from Magnesium Electron Incorporated and from W.R. Grace & Co. Silica particles may be surface-functionalized with cationic inorganic sols via charge-charge attraction and subsequent formation of Si—O-M bonds.

The particles of the disclosed embodiments may also be surface-functionalized with polymers, especially amine containing polymers having amine or amide functionalities such as polyethylenimine, polyallylamine or polyamides, and siloxane polymers. Amine containing polymers may attach to the surface of silica particles via charge attraction upon protonation of the amine at a pH less than about 8. The preparation of silica dispersions having their particle surfaces functionalized with polyamines is described in “Controlled, Simultaneous Assembly of Polyethylenimine Onto Nanoparticle Silica Colloids”, Langmuir, 22, 4198 (2006).

The particles may have their surfaces functionalized by silane coupling agents, or hydrolyzed precursors of silane coupling agents having the general formula:

RₐR′_{b}Si(OR″)_{4-(a+b)},

where a and b are integers from 0 to 3, (a+b) is greater than or equal to 1 and less than or equal to 3, R and R′ are organic groups having from 1-30 carbon atoms and R″ is H, or an organic group having from 1 to 6 carbon atoms.

Alternatively, the silane coupling agent may have the general formula:

RₐSi(X)₄₋ₐ,

where a and R are as defined above and X is a halogen, Cl, Br or I.

Specific examples of silane coupling agents useful for practice of the disclosed embodiments include but are not limited to 3-chloropropyl(trimethoxy)silane, 3-chloropropyl(triethoxy)silane, 3-chloropropyldimethylmethoxysilane, 3-chloropropyltris(trimethylsiloxy)silane, 3-mercaptopropyl(trimethoxy)silane, 3-mercaptopropylmethyl(diethoxy)silane, methacryloxypropyl(trimethoxy)silane, 2-[methoxy(polyethyleneoxy)propyl](trichloro)silane, 2-[methoxy(polyethyleneoxy)propyl](trimethoxy)silane, octyl(trimethoxy)silane, octadecyl(trimethoxy)silane, 3-isocyanatopropyldimethylchlorosilane, 3-isocyanatopropyl(triethoxy)silane, Bis(2-hydroxyethyl)-3-aminopropyltriethoxysilane, aminopropylsilanetriol, 3-aminopropyl(triethoxy)silane, 3-aminopropyl(trimethoxy)silane, N-(2-aminoethyl)-3-aminopropylsilanetriol, N-(2-aminoethyl)-3-aminopropyl(trimethoxy)silane, N-(2-aminoethyl)-3-aminopropylmethyldimethoxysilane, isopropyl(trimethoxy)silane, (3-glycidoxypropyl)methyldimethoxysilane, tetradecyldimethyl(3-trimethoxysilylpropyl)ammonium chloride, (3-trimethoxysilylpropyl)diethylenetriamine and octadecyldimethyl(3-trimethoxysilylpropyl)ammonium chloride.

One disclosed aqueous dispersion comprises metal oxide and/or metal oxy-hydroxide particles that are surface-functionalized with a surface functionalizing agent. The surface functionalizing agent may be applied to the surfaces of the particles by mixing the particles with the surface functionalizing agent at an appropriate ratio in a high speed or high shear mixing apparatus. The appropriate ratio may be determined by measuring the saturation adsorption of the surface functionalizing agent on the particles. The saturation absorption describes the maximum number of surface functionalizing agents that may be adsorbed, or bound to, the particle surfaces per unit surface area, and has the units μmol/m². Typically, saturation adsorptions vary from about 0.5-5 μmol/m². Methods of measuring the saturation adsorption are described in Bringley et al., Langmuir 2006, 22, 4198-4207.

It is highly preferred that the particles and the surface functionalizing agent are brought together at a ratio very near the saturation absorption, or within the range of 80 to 120% of that value, and more preferably within the range of about 90 to 110% of that value. This is preferred because at ranges well below the saturation adsorption stable colloids are not obtained, and at values well above the saturation adsorption, some portion of the surface functionalizing agent will not be bound to the particles but rather remain “free” in solution.

To initiate the surface functionalization reaction, the particles and the surface functionalizing agent are mixed together in a high shear mixing zone within a dispersion medium. It is preferred that the dispersion medium is water, but other solvents or liquids may also be used.

The high shear mixing zone may be provided by a propeller-like mixer, a static mixer, in-line mixers, dispersators, or other high shear mixing apparatus. The mixing efficiency of the apparatus is dependent upon the type of mixing method chosen and the precise geometry and design of the mixer. For propeller-like mixers the mixing efficiency may be approximated by the turnover rate, where the turnover rate is the stir rate (rev/sec.) times the turnover volume (ml/rev)) divided by the aqueous volume. For in-line or static mixers, the mixing efficiency may be approximated by multiplying the sum of the addition rates of the colloidal dispersions by the turnover volume of the mixer. In each case, the mixing efficiency has units of turnovers/sec. It is preferred that the mixing efficiency be greater than about 0.10 turnovers/sec. and more preferably greater than 1 turnover/sec. Complete mixing of the two solutions is preferably accomplished in less than about 10 seconds, and is more preferably accomplished substantially instantaneously.

The aqueous dispersions are stable colloidal dispersions. It is often the surface properties of the particles in the colloid, such as their electrostatic charge, which contribute to the stability of the colloid. Typically the surfaces are significantly charged, positive or negative, so as to provide electrostatic repulsion to overcome forces which would otherwise lead to the aggregation and settling of the particles from the colloid. It has been of interest to surface-functionalize particles, or to “assemble” colloidal particles of opposite charge to achieve specific properties. However, this is often difficult since the surface functionalization or assembly disrupts the electrostatic and steric forces necessary for colloidal stability, and stable colloids are not easily obtained.

Colloidal stability refers to the ability of particles to remain stable in suspension (not to settle or separate from the dispersion). Aqueous dispersions of particles that remain in suspension for more than 30 days can be considered stable. It is preferred that the dispersion maintains stability for more than six months. The colloidal stability of a dispersion may be determined by a number of methods. The dispersion may be placed in a tall, narrow glass container and the settling rate monitored visually over a period of months. A more quantitative approach is to measure the average particle size diameter of the particles in the dispersion. Unstable colloids show a tendency to aggregate or agglomerate, that is, particles begin to “stick” to one another. This aggregation is observed as an increase in the average particle diameter of the particles in the dispersion. Stable colloids show very little change in the average particle size diameter over a period of months and preferably over a period of greater than six months.

It is important that the surface functionalization of the particles be performed in such a manner so as to provide a stable colloidal suspension that has a high concentration of solids and a low viscosity. It is preferred that the concentration of solids is at least greater than 5.0% by weight per weight of colloidal suspension, and more preferably greater than 10.0%. It is preferred that that the viscosity is less than 1000 centipoise and, more preferably, less than 100 centipoise.

The aqueous dispersions of the disclosed embodiments should not contain aggregates, agglomerates, or the like. Aggregation or agglomeration of the surface-functionalized particles of the disclosed embodiments can lead to poor performance and poor utilization of chemistry. The presence of aggregates and agglomerates can be determined by measuring the average particle diameter of the dispersion and the particle size distribution. Because the surface functionalizing agents are molecular in scale, the average particle diameter should not change significantly upon application of the surface functionalizing agent to the particles. The degree of change is dependent upon the size of the surface functionalizing agent and the size of the particles. It is preferred that, upon application of the surface functionalizing agent, the average particle diameter of the surface-functionalized particles should increase by not more than a factor of three, and more preferably by not more than a factor of two.

The particle size(s) of the colloidal surface-functionalized particles of the aqueous dispersions disclosed may be characterized by a number of methods, or combination of methods, including coulter methods, light-scattering methods, sedimentation methods, optical microscopy and electron microscopy. Light-scattering methods may sample 10⁹ or more particles and are capable of giving excellent colloidal particle statistics. Light-scattering methods may be used to give the percentage of particles existing within a given interval of diameter or size, for example, 90% of the particles are below a given value. Light-scattering methods can be used to obtain information regarding mean particle size diameter, the mean number distribution of particles, the mean volume distribution of particles, standard deviation of the distribution(s) and the distribution width for nanosize particles.

In the disclosed aqueous dispersions, it is preferred that at least 90% of the surface-functionalized particles be less than 4-times the mean particle size diameter, and more preferably that at least 90% of the surface-functionalized particles are less than 3-times the mean particle size diameter. The mean particle size diameter may be determined as the number weighted (mean size of the total number of particles) or as the area, volume or mass weighted mean. It is preferred that the volume or mass weighted mean particle size diameter be determined, since larger particles having a much greater mass are more prominently counted using this technique. In addition, a narrow size-frequency distribution for the surface-functionalized particles may be obtained. A measure of the volume-weighted size-frequency distribution is given by the standard deviation (sigma) of the measured particle sizes. It is preferred that the standard deviation of the volume-weighted mean particle size diameter of the surface-functionalized particles is less than the mean particle size diameter, and more preferably less than one-half of the mean particle size diameter.

The treated textile of the disclosed embodiments has an oil repellency of 3 or greater, a water repellency of 3 or greater and a fluorine concentration by weight of treated fabric of from about 20 to about 900 ppm comprising a textile substrate treated with an aqueous dispersion of surface-functionalized particles and a fluorochemical. It has been discovered that the combination of surface-functionalized particles and fluorochemicals significantly lowers the amount of fluorochemical necessary for a given fabric performance. It has further been discovered that such finishes do not increase the flammability of textiles and fabrics. We propose, but are not bound by, the following explanation of the synergistic effects that produce the embodiments described herein. The surface-functionalized particles disclosed herein significantly lower the amount of fluorochemical necessary to produce a given performance (water- and oil-repellency) on the textile. The textile as treated is not increased in flammability for two reasons. First, due to the fact that the flammable portion of the finish, that is, the fluorochemical, is very low, the treated textile disclosed herein may have a fluorochemical concentration less than 0.1% by weight (less than 1000 ppm). The treated textile of the disclosed embodiments may have a fluorochemical concentration, measured as the % atomic fluorine (F) on the finish, less than 0.05% and even less than 0.03%. Second, the treating solution comprises a significant portion of surface-functionalized particles, preferably inorganic particles, that are non-combustible and non-flammable and therefore do not increase the flammability of the treated textile.

Fluorochemicals useful for practice of the embodiments disclosed herein include any of the commercial fluorochemicals used to impart stain and oil/water resistance to textile fabrics. Fluorochemicals are typically complex random co-polymers that contain a variety of substituents including fluoroalkyl co-monomers containing organo-fluorine groups that provide both water and oil repellency, non-fluorinated co-monomers, such as alkyl monomers, to provide water repellency and to achieve good film-forming properties, small amounts of hydrophilic monomers to aid in stabilization of the polymer in aqueous solution, and cross-linkable groups, such as amines, so that the complex polymer can be permanently cross-linked to functional groups on the natural or synthetic fabric.

Suitable fluorochemicals include any of the organo-fluorine group-containing organic compounds including polymeric and oligomeric compounds. These polymeric and oligomeric compounds typically contain one or more organo-fluorine groups that contain a perfluorinated carbon chain having from 3 to about 16 carbon atoms and preferably 4 to 8 carbons. The organo-fluorine groups may be straight-chained, branched or cyclic fluorinated alkyl or alkylene groups. Fully fluorinated groups are preferred. Perfluorinated aliphatic groups of the general formula (CₙF₂ₙ₊₁—) are the most preferred organo-fluorine groups. Especially preferred are organo-fluorine groups wherein n is between 4 and 8, since such groups show the least toxicity and persistence in the environment.

The fluorochemicals useful in the disclosed embodiments preferably contain non-fluorinated co-monomers. It is preferred that the concentration of non-fluorinated co-monomers be as high as possible without sacrificing the stain and water/oil repellent properties of the polymer. Typical non-fluorinated co-monomers may be methyl methacrylate, dodecylmethacrylate, octadecylmethacrylate, butyl acrylate, and polyvinylchloride. The non-fluorinated co-monomers may also contain hydrophilic groups to aid in the dispersibility of the polymer in aqueous solution. Examples include polyethyleneglycol-methacrylates and -acrylates, and 2-hydroxyethylacrylate.

The fluorochemicals also preferably contain a cross-linkable moiety. A cross-linkable moiety refers to an organic functional group that may react at a temperature between about 20-150° C. and form a covalent bond with functionalities on the surfaces of the individual fibers of the fabric. The functional group may react directly with functionalities on the surface of the individual fibers or may react with a “cross-linker”, a molecule that has multiple reactive sites and essentially binds, or reacts with, both the fluoropolymer and the fabric or the fluoropolymer and functionalities on the surface-functionalized particle. Examples of cross-linkable moieties include carboxylate groups, hydroxyl groups, amine groups, amide groups, and thiol groups. Examples of cross-linkers include melamine resins, isocyanates and polyisocyanates. Preferred cross-linkers are blocked polyisocyanates which react only at elevated temperatures usually during the drying and curing stages.

Fluorochemicals are typically provided to the textile industry as a concentrate that is later diluted to a specific concentration and is then applied to the fabric. The term “treating solution” is hereafter used to refer to the diluted concentrate containing the surface-functionalized or -modified particles and fluorchemical, which may include additives such as surfactants, wetting aids, solvents, and cross-linkers, that is applied to the fabric. The treating solution is applied to the fabric by padding (dipping), spraying or foaming of the fabric with the solution. The wet pickup of the fabric typically ranges from 20-80% (by weight). One skilled in the art may determine the proper dilution of the concentrate by knowledge of the fabric weight and the wet pick-up of the particular process used and the desired performance (water and oil repellency rating) of the fabric.

As described above, fluorochemicals are typically complex random co-polymers and contain a variety of substituents in addition to organo-fluorine containing components. Further, the percentage of organo-fluorine containing monomers and the chemical structure of the monomers may vary significantly between different manufacturers. In addition, fluorochemicals may contain emulsifiers and dispersion aids, and may be sold at a variety of concentrations, that is, as measured by the percentage of solids. Further, not all of the components of the concentrate are harmful to the environment. Manufacturers continue to optimize these formulations with the aim of decreasing the concentrations of harmful chemicals, in particular the substituents that contain organo-fluorine groups.

To compare directly the potential environmental benefits (advantages or disadvantages) of given commercial textile treatment formulations, it is necessary to measure the concentration of organo-fluorine containing groups. Organo-fluorine groups contain atomic fluorine (F). The proportion of atomic fluorine (F) in the concentrate is related directly to the concentration of organo-fluorine containing groups in the concentrate. The atomic fluorine (F) concentration may be determined simply via elemental analysis of the concentrate, and can therefore be used as a measure of the active fluorochemical concentration in commercial formulations. This analysis provides an appropriate comparison of commercial fluorochemicals (i.e., as a measure of the environmentally harmful component of the concentrate), since the fluorine concentration is directly related to the degree of organo-fluorine groups in the formulation.

The disclosed embodiments provide a treated textile fabric wherein the fluorine concentration by weight per weight of treated textile fabric is from about 20 to about 900 ppm. The fluorochemical is applied to the fabric at a solids-on-fabric (SOF) level from about 20-900 ppm F, as measured from the fluorine concentration in the fluorochemical.

The SOF is defined by the formula:

SOF=[(fraction wet pick-up)×(conc. F in treating solution)]/weight fabric

The Fluorine concentration F (in parts-per-million per weight of fabric, ppm F) as applied to fabric can therefore be determined from the treating solution concentration and the wet pick-up using the following equation:

$$p p m F = \frac{[ \begin{matrix}( wet pick up ( g ) ) \times ( g conc . / g treating soln . ) \times \\ ( F conc . ( g / g conc . ) )\end{matrix} ]}{weight fabric ( g )} \times {10}^{6}$$

This analysis gives an accurate determination of the fluorochemical content used to produce a given performance and further is able to elucidate potential environmental benefits, since an equal performance at a lower fluorochemical concentration represents a clear environmental benefit.

The disclosed method provides a treated textile article wherein the flammability of the textile passes fire code flammability standards. Fire codes are dictated by the area of application of the textile and by local, state, federal and other government institutions that oversee the codes. For transportation textiles such as automotive, trains, and planes, a particularly important standard is the Federal Motor Vehicle Safety Standard, FMVSS-302. For upholstery, cubicle curtains and draperies a particularly important standard is set by the National Fire Protection Association, NFPA-701-99. Another important flammability standard for draperies is the International Maritime Organizations IMO A.471 (XII)-A.563 (14) standard. Textiles and Fabrics which pass this test must have (1) an afterflame of less than 5 seconds, (2) surface flash not exceeding 100 mm and (3) an average char length of less than 150 mm; using the test apparatus and procedure as specified by the IMO A.471 (XII)-A.563 (14) procedure. In general, a textile fabric is selected for a particular application with fore-knowledge that the textile (or fabric) passes fire codes established for that application.

In the practice of the disclosed embodiments, the application of the treating solution, that is, an aqueous dispersion of surface-functionalized or surface-modified particles and a fluorochemical, should not cause the textile article to fail flammability codes established for that particular application. This is typically not true for conventional fluorochemical treatments wherein the application of the fluorochemical may increase flammability and result in a test failure, as illustrated by the Examples and Comparison Examples herein. This renders the textile article unsuitable for its intended application. One skilled in the art may determine the amount and concentration of treating solution to use in treating the fabric, so that the desired stain resistance is achieved and the fabric passes the fire code or codes for its' intended application. For some applications of textiles in which the fire codes may be particularly stringent, it may be necessary to employ an inherently flame retardant yarn from which to weave the fabric. Inherently flame retardant yarns have a flame retardant added during the manufacture of the fiber that comprises the yarn. Again, one skilled in the art may determine the amount and concentration of treating solution to use in treating the fabric, so that the desired stain resistance is achieved and the fabric passes the fire code(s).

Another embodiment provides a treated textile comprising a textile substrate treated with an aqueous dispersion of surface-functionalized or surface-modified particles, a fluorochemical and a flame retardant chemical, wherein the flammability of the textile passes fire code flammability standards and the treated textile has an oil repellency of 3 or greater, a water repellency of 3 or greater and a fluorine concentration by weight of treated fabric of from about 20 to about 900 ppm.

Flame retardant chemicals may further improve the flammability characteristics of the textile. Suitable flame retardant chemicals are selected from antimony compounds, brominated compounds, aluminum silicates, aluminum hydroxides, borate salts, organic halogen compounds, amine containing compounds, sulfur containing compounds and phosphorus containing compounds. It is preferred that the flame retardants are selected from phosphorous, phosphate, phosphate or organophosphorous compounds. The choice of the flame retardant chemical may vary depending upon the fabric composition of the treated textile. One skilled in the art may select the appropriate flame retardant based upon fabric construction and the required level of flame retardancy. Certain flame retardants are specifically designed for cotton, for example, Pyrovatex® CP. Others are better suited for polyester, for example, Pyrovatex® SVC and Flovan CGN. Still other flame retardant chemistries are required for nylon and acrylic. One skilled in the art may determine the most suitable flame retardant and the required concentration by means of experimentation.

The textile article of the disclosed embodiments is treated with an aqueous dispersion of surface-functionalized, or surface modified, particles and a fluorochemical and a flame retardant chemical so that the flammability of the textile is not significantly increased so as to fail specified fire codes. One of the complexities involved in supplying flame retardant textiles to the industry is the wide array of testing measures, standards and laboratory techniques for determining the flammability of fabrics and the fact that quantitative data are often not available from specific tests. The flammability of fabrics is often determined on a pass/fail basis only. To resolve this problem, in the past twenty-years, cone calorimetry has been developed as a method to collect quantitative data regarding the flammability of a specimen, for example, textile, plastic, or wood. In cone calorimetry, a small specimen is exposed to a constant heat flux, usually near 50 kW/m², and, as the specimen burns, several parameters are measured. The parameters include the heat release rate versus time, the mass loss rate of the specimen, the ignition time, the specific heat of combustion, and most importantly, the peak heat release rate of the specimen. These parameters can be measured to within an accuracy of about ±10%. The peak heat release rate gives the maximum amount of heat released/sec while the specimen is burning most rapidly. This parameter, and the heat release rate over time, are important because they can be a predictor of the ability of a specimen to cause a fire when ignited.

Textile fabrics may have widely variable flammability characteristics as measured by cone calorimetry dependent upon their composition (for example, polyester, nylon, cotton), the fabric weave (open weave or dense weave), their weight and topical applications, for example, fluorochemicals, and sizing agents, applied to the fabric. In the practice of the disclosed methods, it is preferred that the treating solution, comprising surface-modified or surface-functionalized particles and a fluorochemical, does not increase the peak heat release rate by more than 70%, and the mass loss rate by more than 50%. It is further preferred that the treating solution does not increase the peak heat release rate by more than 50%, the mass loss rate by more than 40%. It is most preferred that the treating solution does not increase the peak heat release rate by more than 30%, and the mass loss rate by more than 25%.

In another embodiment, disclosed is a textile article treated with an aqueous dispersion of surface-functionalized or surface-modified particles, a fluorochemical, and a flame retardant chemical. The flame retardant chemical may reduce the heat release rate and mass loss rate of the textile and potentially offset the effects of the fluorochemical. It is preferred that the treating solution comprising surface-functionalized particles, a fluorochemical and a flame retardant chemical does not increase the peak heat release rate by more than 10%, and the mass loss rate by more than 10%. It is further preferred that the treating solution decreases the peak heat release rate by more than 20%, and decreases the mass loss rate by more than 15%. It is most preferred that the treating solution decreases the peak heat release rate by more than 50%, and decreases the mass loss rate by more than 25%.

The aqueous dispersion of the disclosed embodiments may be applied to textiles by a number of methods common in the art including padding, spraying, foaming or other methods. Coating aids, such as dispersants, wetting aids, and emulsifiers, may be employed in the treating solution if desired. The aqueous dispersion of the disclosure may be combined with other textile coating chemistries, such as UV absorbers, antimicrobials, lubricants and fabric softeners. One skilled in the art may determine the proper concentration of the various chemistries via experimentation.

In order to provide durability to everyday wear and to laundering it is preferred that the aqueous dispersion contain a crosslinking agent. A crosslinking agent is typically a polymer, oligomer or small molecule that is reactive with functional groups, such as amines and hydroxyl groups, on the fabric and with similar functionalities on the fluorochemical, surface-functionalized particles and other addenda present in the treating solution. Thus the dried coating is chemically bound to the fabric. Suitable crosslinkers for practice of the disclosed embodiments are melamine, epoxy, isocyanate or polyisocyanate resins. Preferred cross-linkers are blocked polyisocyanates which react only at elevated temperatures, usually during the drying and curing stages.

After application of the aqueous dispersion to the fabric, the water is removed by drying, typically at elevated temperature. It is preferred that the drying is done at a temperature between about 70 and 125° C. It is further preferred that after the fabric is dry it is further cured to facilitate the cross-linking reaction so as to increase the durability of the coating. It is preferred that the curing temperature is between about 125-199° C., and more preferably between 150 and 175° C. Some polyester flame retardant chemicals may require a thermosol treatment wherein the flame retardant is absorbed into the fibers of the fabric. Typically this involves curing the fabric at a temperature between 180 and 200° C. In this case it is advisable to cure the finish at the manufacturers recommended temperature.

If properly applied, the aqueous treating dispersion provides a soil and stain resistant treated textile that repels both oil and water. The degree of repellency can be determined by a number of methods common in the industry. The standard methods are defined in the “description of testing methods” section herein. It is preferred that the treated textile has a water repellency of at least 3, and more preferably 4 or greater as given by the 3M test method. It is preferred that the treated textile has a oil repellency of at least 3, and more preferably 4 or greater as given by the AATCC-118 test method. It is preferred that the treated textile is durable to multiple launderings, and continues to show a high degree of repellency after repeated washings. It is preferred that the treated textile is durable to at least 5 launderings, and more preferably at least 10 launderings, and even more preferably at least 25 or more launderings.

### EXAMPLES

The following non-limiting examples are provided to illustrate the invention.

Materials

All material concentrations are given as a weight to weight percentage unless otherwise noted. All dispersions are in water unless otherwise noted.

SFN-123 is a surface-functionalized particle-based water and oil stain repellent available from G3 Technology Innovations. It is 12.0% solids and contains 2.0% atomic fluorine (F) on a weight/weight basis, (g/g concentrate). Preparation of this surface-functionalized particle-based water and oil stain repellent is described in U.S. patent application Ser. No. 11/859,308 and is incorporated herein by reference.

TG-580®, a trademarked product sold by Daikin America, is a 30.0% fluorochemical dispersion. Elemental analysis indicated that the fluorine concentration was 28.52% per gram of solids, or 0.11 g/g concentrate.

Pyrovatex® SVC, a trademarked product sold by Huntsman Specialty Chemicals, is a 50.0% aqueous solution of a organophosphorous flame retardant.

Fabric Compositions.

Fabrics chosen for study were polyester fabric of varying inherently flame retardant yarn compositions. The flame retardant yarn in each case were used was Trevira\tilde{®} The proportion of inherently flame retardant yarn in the fabric was in each designated as “FR” whereas the proportion of non inherently flame retardant yarn was designated as “non-FR”.

Description of Testing Methods

Materials were tested using standardized methods as given in the textile manual of the American Association of Textile Chemists and Colorists, 1993.

Water Repellency (WR) Test

Water repellency was tested according to the 3M water repellency test II (May 1992). The rating scale is 0-10 with 0 indicating the lowest and 10 the highest degree of repellency. The 3M test scale consists of a series of mixtures of isopropanol (IPA) and water that systematically varies the surface tension. The 3M compositions and the rating scale are given in the Table below.

| Volume % water | Volume % IPA | Score |
|---|---|---|
| 100 | 0 | 0 |
| 90 | 10 | 1 |
| 80 | 20 | 2 |
| 70 | 30 | 3 |
| 60 | 40 | 4 |
| 50 | 50 | 5 |
| 40 | 60 | 6 |
| 30 | 70 | 7 |
| 20 | 80 | 8 |
| 10 | 90 | 9 |
| 0 | 100 | 10 |

A test sample is placed on a flat, horizontal surface and three drops of each liquid above are applied to the test sample in small drops about 3-5 mm in diameter using a pipette. The drops are allowed to stand for 10 seconds and if after this time at least two of the three drops are still visible on the surface the sample is deemed to have passed the test. In all cases scores are assessed as the highest rating for which the fabric passes the test. If all of the liquids wet the fabric, the example is given a failure rating (F).

Oil Repellency (OR) Test

Oil repellency was tested according to the AATCC test method 118-2000. The rating scale is 0-8 with 0 indicating the lowest and 8 the highest degree of repellency. The compositions and the rating scale are given in the Table below.

| Liquid | Score |
|---|---|
| Mineral oil | 1 |
| 65/35 mineral oil/n-hexadecane | 2 |
| n-hexadecane | 3 |
| n-tetradecane | 4 |
| n-dodecane | 5 |
| n-decane | 6 |
| n-octane | 7 |
| n-heptane | 8 |

A test sample is placed on a flat surface, horizontal surface and one or two drops of each liquid above are applied to the test sample in small drops about 3-5 mm in diameter using a pipette. The drops are allowed to stand for 60 seconds and if after this time they are still visible on the surface and no visible wetting is observed the sample is deemed to have passed the test. In all cases scores are assessed as the highest rating for which the fabric passes the test. If all of the liquids wet the fabric, the example is given a failure rating (F).

Application of Treatment Solutions onto Fabrics.

Materials were diluted with water as necessary to obtain treating solutions with active ingredients as given in the Tables. All Examples and Comparison Examples were evaluated by applying the treatment solutions onto 12 inch×18 inch pieces of fabric. Excess treating solution was removed from the cloth by applying pressure via a nip roller. The weight of the fabric before and after application of the treating solution was measured and the wet pick-up of the solution calculated as [(weight after treatment−weight before treatment)/weight before treatment]×100%. Treated fabrics were tested as given above.

Determination of Fluorine Concentration.

The Fluorine concentration F (in parts-per-million per weight of fabric, ppm F) as applied to fabric was determined from the treating solution concentration and the wet pick-up using the following equation:

$$p p m F = \frac{[ \begin{matrix}( wet pick up ( g ) ) \times ( g conc . / g treating soln . ) \times \\ ( F conc . ( g / g conc . ) )\end{matrix} ]}{weight fabric ( g )} \times {10}^{6}$$

Flammability Testing.

FMVSS-302 Testing: Three test specimens were cut from a sample fabric, 4 inch×14 inch, and the specimen held on 3 sides by a test frame and the frame placed in a horizontal position inside a test cabinet. The open edge of the specimen was subjected to a 1.5 inch high flame for a period of 15 seconds. The FMVSS-302 test measures the time of burning for a 10 inch portion of the test specimen. The 10 inch portion begins 1.5 inch in from the edge of the specimen. If the burn does not proceed beyond the 2 inch benchmark within 60 seconds a rating of “no burn rate” is assigned. If the specimen continues to burn beyond the benchmark, then the burn rate is measured at 60 second intervals. The test is repeated three times for each sample fabric and the average burn rate calculated. An average burn rate in excess of 4.0 inch/minute results in the assignment of “fail” for the sample fabric, an average burn rate less than 4.0 inch/minute, “no burn rate”, or “no ignition” results in the assignment of “pass” for the sample fabric.

NFPA-701-99 (small-scale) Testing: Three test specimens, 6 inch×15 inch, were cut from a sample fabric, and the specimen held by a clamp in a vertical position inside a test cabinet. The bottom edge of the specimen is subjected to a flame produced with methane gas for a period of 45 seconds. The NFPA-701-99 method determines the total burn of the fabric on a weight basis and the burn-time of “flaming drips” that are released as the fabric melts. The sample was weighed before and after the burning procedure. The test is repeated three times for each sample fabric and the average weight loss as a result of burning was determined. If the average weight loss is less than 40% of the original weight and the flaming drips extinguish (on average) in less than 2 seconds, the sample passes NFPA-701-99. If the average weight loss is greater than 40% of the original weight and/or the flaming drips extinguish (on average) in greater than 2 seconds, the sample fails NFPA-701-99.

Preparation of Stain Resistant Polyester Fabrics.

### Example 1

A 100% non-FR polyester fabric for use in the automotive industry was dip-coated into an aqueous solution containing 25 g/L SFN-123 to a wet pick-up (WPU) of 75.2%, calculated Fluorine concentration=380 ppm. The fabric was then dried at 125° C. for 6 minutes and cured at 160° C. for 1 minute. The fabric was then tested for water and oil repellency and the flammability of the fabric tested according to the automotive industry standard FMVSS-302. The results are reported in Table 1.

### Example 2

Performed in an identical manner as that of Example 1 except that the concentration of SFN-123 was 50 g/L. WPU=74.2%, Fluorine concentration (calc.)=740 ppm.

### Comparison Example 3

Performed in an identical manner as that of Example 1 except that the surface-functionalized particle-based stain repellent SFN-123 was replaced by the fluoropolymer stain repellent TG-580 at 25 g/L. WPU=76.6%, Fluorine concentration (calc.)=2,100 ppm.

### Comparison Example 4

Performed in an identical manner as that of Example 1 except that the surface-functionalized particle-based stain repellent SFN-123 was replaced by the fluoropolymer stain repellent TG-580 at 50 g/L. WPU=74.7%, Fluorine concentration (calc.)=4,100 ppm.

### Example 5

Performed in an identical manner as that of Example 1 except that the fabric was dip coated into a solution containing 25 g/L SFN-123 and 30 g/L Pyrovatex® SVC. WPU=77.3%, Fluorine concentration (calc.)=390 ppm.

TABLE 1
Water and oil repellency ratings and flammability (FMVSS-302)
for Examples (E) and Comparison Examples (CE) applied
to 100% non-FR polyester fabric.

| Example (E) or | Composition | | | | Avg. Burn | |
|---|---|---|---|---|---|---|
| Comparison | treating | | | | rate | FMVSS |
| Example (CE) | solution | WR | OR | Notes | (in./min.) | 302 |
| E-1 | 25 g/L SFN- | 8 | 7 | SE/ | none | pass |
| | 123 | | | NBR | | |
| E-2 | 50 g/L SFN- | 8 | 7 | SE/ | none | pass |
| | 123 | | | NBR | | |
| CE-3 | 25 g/L | 7 | 6 | SE | 4.4 | fail |
| | fluoropolymer | | | | | |
| CE-4 | 50 g/L | 8 | 7 | SE | 4.8 | fail |
| | fluoropolymer | | | | | |
| E-5 | 25 g/L SFN- | 8 | 7 | NI | none | pass |
| | 123 + 25 g/L | | | | | |
| | Pyrovatex ® | | | | | |
| | SVC | | | | | |

WR = water repellency score;
OR = oil repellency score.
SE = self extinguishes,
NBR = no burn rate,
NI = no ignition, does not ignite.

The data of Table 1 shows that the inventive Examples with 100% non-FR polyester fabrics finished with the surface-functionalized particle-based stain repellent (SFN-123) have high water and oil repellency and also pass the flammability standard for motor vehicles, FMVSS-302. The fabrics so treated self-extinguish and have no measurable burn rate. The Comparison Example, having 100% non-FR polyester fabric treated with a fluoropolymer stain repellent, while having good water and oil repellency, does not pass the FMVSS-302 standard and has a measurable average burn rate of greater than 4.0 inches/minute. The data of Table 1 show that further improvements in flammability can be achieved by combining the surface-functionalized particle-based stain repellent with a flame retardant treatment. Fabrics so treated do not show ignition in the FMVSS-302 test.

### Comparison Example 6

A polyester fabric weaved with 100% inherently-FR yarn was cut into test specimens and its flammability examined via test method NFPA-701-99 as described above. The results are reported in Table 2.

### Example 7

A polyester fabric weaved with 100% inherently-FR yarn (identical to that used in comparison Example 6) was dip-coated into an aqueous solution containing 25 g/L SFN-123 to a wet pick-up of 91.7%, Fluorine concentration (calc.)=460 ppm. The fabric was then dried at 125° C. for 6 minutes and cured at 160° C. for 1 minute. The fabric was then tested for water and oil repellency and the flammability of the fabric tested according to the upholstery standard NFPA-701-99. The results are reported in Table 2.

### Example 8

Performed in an identical manner as that of Example 7 except that the concentration of SFN-123 was 50 g/L. WPU=74.5%, Fluorine concentration (calc.)=750 ppm.

### Comparison Example 9

A polyester fabric weaved with 56% non-FR yarn and 44% inherently-FR yarn was cut into test specimens and its flammability examined via test method NFPA-701-99 as described above. The results are reported in Table 2.

### Example 10

A polyester fabric weaved with 56% non-FR yarn and 44% inherently-FR yarn (identical to that used in comparison Example 9) was dip-coated into an aqueous solution containing 25 g/L SFN-123 to a wet pick-up of 92.9%, Fluorine concentration (calc.)=460 ppm. The fabric was then dried at 125° C. for 6 minutes and cured at 160° C. for 1 minute. The fabric was then tested for water and oil repellency and the flammability of the fabric tested according to the upholstery standard NFPA-701-99. The results are reported in Table 2.

### Example 11

Performed in an identical manner as that of Example 10 except that the concentration of SFN-123 was 50 g/L. WPU=86.9%, Fluorine concentration (calc.)=870 ppm.

### Comparison Example 12

A polyester fabric weaved with 100% non-FR yarn was cut into test specimens and its flammability examined via test method NFPA-701-99 as described above. The results are reported in Table 2.

### Example 13

A polyester fabric weaved with 100% non-FR yarn (identical to that used in comparison example 12) was dip-coated into an aqueous solution containing 30 g/L SFN-123 and 120 g/L Pyrovatex® SVC to a wet pick-up of 95.1%, Fluorine concentration (calc.)=570 ppm. The fabric was then dried at 125° C. for 6 minutes and cured at 160° C. for 1 minute. The fabric was then tested for water and oil repellency and the flammability of the fabric tested according to the upholstery standard NFPA-701-99. The results are reported in Table 2.

### Example 14

Performed in an identical manner as that of Example 13 except that the concentration of SFN-123 was 50 g/L and the concentration of Pyrovatex® SVC was 200 g/L. WPU=83.8%, Fluorine concentration (calc.)=840 ppm.

TABLE 2
Water and oil repellency ratings and flammability (NFPA-701-99) for
Examples (E) and Comparison Examples (CE) on polyester fabrics containing a blend
of inherently flame retardant (FR) and non-inherently flame retardant (non-FR) yarns.

| Example (E) or | | | | | | |
|---|---|---|---|---|---|---|
| Comparison | Composition | | | Fabric | Avg. Mass | NFPA- |
| Example (CE) | treating solution. | WR | OR | composition | loss weight % | 701-99 |
| CE-6 | none | F | F | 100% FR | 14.5 | pass |
| E-7 | 25 g/L | 7 | 7 | 100% FR | 18.0 | pass |
| | SFN-123 | | | | | |
| E-8 | 50 g/L | 8 | 7 | 100% FR | 19.1 | pass |
| | SFN-123 | | | | | |
| CE-9 | none | F | F | 56% non- | 3.4 | pass |
| | | | | FR/ | | |
| | | | | 44% FR | | |
| E-10 | 25 g/L | 6 | 5 | 56% non- | 21.0 | pass |
| | SFN-123 | | | FR/ | | |
| | | | | 44% FR | | |
| E-11 | 50 g/L | 8 | 7 | 56% non- | 10.2 | pass |
| | SFN-123 | | | FR/ | | |
| | | | | 44% FR | | |
| CE-12 | none | F | F | 100% non- | 44.0 | fail |
| | | | | FR | | |
| E-13 | 30 g/L | 8 | 7 | 100% non- | 21.0 | pass |
| | SFN-123 + | | | FR | | |
| | 120 g/L | | | | | |
| | Pyrovatex ® | | | | | |
| | SVC | | | | | |
| E-14 | 50 g/L | 8 | 7 | 100% non- | 10.2 | pass |
| | SFN-123 + | | | FR | | |
| | 200 g/L | | | | | |
| | Pyrovatex ® | | | | | |
| | SVC | | | | | |

The data of Table 2 show that the surface-functionalized particles of the disclosed embodiments can be applied to fabrics that are inherently flame retardant, are not inherently flame retardant or are blends of inherently flame retardant and non inherently flame retardant yarns, while giving excellent water- and oil-repellency scores and passing the upholstery, drapery and curtains fire code NFPA-701-99. The disclosed embodiments provide highly water- and oil-repellent finishes even for 100% non-FR polyester that pass the NFPA-701-99 code. Application of a flame retardant further improves the flame retardant properties of the treated textile.

It will be appreciated that various of the above-disclosed embodiments, methods and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A treated textile comprising:
a textile substrate treated with an aqueous dispersion of surface-functionalized particles and a fluorochemical, wherein the treated textile exhibits oil repellency, water repellency, has a low fluorine concentration, and is flame resistant.

2. The treated textile of claim 1, wherein the treated textile exhibits average burn rate less than about 4.0 inch/minute, as determined by FMVSS-302.

3. The treated textile of claim 1, wherein the treated textile exhibits an average weight loss less than about 40% of the original weight, and the flaming drips extinguish, on average, in less than about 2 seconds, as determined by NFPA-701-99.

4. The treated textile of claim 1, wherein the treated textile exhibits an afterflame of less than about 5 seconds, surface flash not exceeding about 100 mm and an average char length of less than about 150 mm as specified by the IMO A.471 (XII)-A.563 (14) procedure.

5. The treated textile of claim 1, wherein the treated textile does not increase a peak heat release rate by more than about 70%, and a mass loss rate by more than about 50% as determined by cone calorimetry.

6. The treated textile of claim 1 wherein said fluorochemical is chemically bound to a surface of said surface-functionalized particles and said surface of said surface-functionalized particles has been surface-functionalized with an agent chosen from the group of surface functionalizing agents consisting of: polymers; cationic inorganic sols; silane coupling agents; and hydrolyzed precursors of silane coupling agents.

7. The treated textile of claim 1 wherein said surface-functionalized particles comprise surface-functionalized inorganic particles.

8. The treated textile of claim 7 wherein said surface-functionalized inorganic particles are selected from metal-oxide and/or metal oxy-hydroxide particles having a mean particle diameter from 2 to 500 nm.

9. The treated textile of claim 8 wherein said metal-oxide particles are selected from the group of aqueous dispersible particles consisting of: silica; alumina; zirconia; titania; zinc oxide, and mixtures thereof.

10. The treated textile of claim 7 wherein said surface-functionalized inorganic particles are silicon oxide.

11. The treated textile of claim 1 wherein said surface-functionalized particles have been functionalized with cationic inorganic sols of aluminum and zirconium selected from the group consisting of: aqueous solutions of ZrOCl₂; ZrO(NO₃)₂; ZrO(OH)acetate; and Al₂(OH)₅Cl.

12. The treated textile of claim 1 wherein said surface-functionalized particles have been functionalized with polymers.

13. The treated textile of claim 12 wherein said polymers are amine-containing polymers having amine or amide functionalities chosen from the group consisting of: polyethylenimine; polyallylamines; polyamides; and siloxane polymers.

14. The treated textile of claim 1 wherein said surface-functionalized particles have been functionalized with silane coupling agents, or hydrolyzed precursors of silane coupling agents having the general formula:
RₐR′_{b}Si(OR″)_{4-(a+b)},
where
a and b are integers from 0 to 3;
(a+b) is greater than or equal 1 and less than or equal to 3;
R and R′ are organic groups having from 1-30 carbon atoms; and
R″ is H, or an organic group having from 1 to 6 carbon atoms.

15. The treated textile of claim 1 wherein said surface-functionalized particles have been functionalized with silane coupling agents, or hydrolyzed precursors of silane coupling agents having the general formula:
RₐSi(X)₄₋ₐ,
where a is an integer from 1 to 3;
R is an organic group having from 1-30 carbon atoms; and
X is a halogen, Cl, Br or I.

16. The treated textile of claim 1, wherein
said treated textile exhibits an oil repellency of at least 3.

17. The treated textile of claim 1, wherein said treated textile exhibits a water repellency of at least 3.

18. The treated textile of claim 1, wherein said treated textile has a fluorine concentration by weight of treated textile of from about 20 to 900 ppm.

19. The treated textile of claim 1 further including at least one flame retardant chemical.

20. The treated textile of claim 19, wherein said treated textile exhibits an oil repellency of at least 3.

21. The treated textile of claim 19, wherein said treated textile exhibits a water repellency of at least 3.

22. The treated textile of claim 19, wherein the flame retardant chemical is selected from the group consisting of: antimony compounds; brominated compounds; aluminum silicates; aluminum hydroxides; borate salts; organic halogen compounds; amine containing compounds; sulfur containing compounds; and phosphorus containing compounds.

23. The treated textile of claim 19, wherein the flame retardant chemical is selected from the group consisting of phosphorous, phosphate, phosphite and organophosphorous compounds.

24. A method for treating textiles to impart stain resistance and flame resistance comprising:
a. providing a textile substrate;
b. contacting said substrate with a stable aqueous dispersion of surface-functionalized particles and a fluorochemical to produce a treated textile substrate; and
c. finishing said treated textile substrate, wherein the flammability of the finished and treated textile substrate passes a fire code flammability standard selected from the group consisting of:
an average burn rate less than 4.0 inch/minute, as determined by FMVSS-302;
the average weight loss is less than 40% of the original weight and the flaming drips extinguish (on average) in less than 2 seconds, as determined by NFPA-701-99; and
does not increase the peak heat release rate by more than 70%, and the mass loss rate by more than 50% as determined by cone calorimetry; and
has an oil repellency of 3 or greater, a water repellency of 3 or greater and a fluorine concentration by weight of treated textile of from about 20 to about 900 ppm.

25. An aqueous dispersion, for treating surfaces in order to impart water repellency, oil repellency, and flame resistance, comprising
surface functionalized inorganic particles, comprising metal oxide particles, ranging in size between 2 to 500 nm, that have been surface functionalized with a surface functionalizing agent, stably suspended in an aqueous medium, and at least one flame retardant chemical; and
a fluorochemical chemically bound to the surface of said surface functionalized particles, where the concentration of fluorine in the aqueous dispersion is low.
